(19) United States
(12) Patent Application Publication
(10) Pub. No.: US 2012/0062484 A1
(43) Pub. Date: Mar. 15, 2012

(54) ELECTRONIC DEVICE WITH NAVIGATION KEYS AND NAVIGATION METHOD THEREOF

(75) Inventors: XIAO-BING GAO, Shenzhen City (CN); YIN-GE ZHANG, Shenzhen City (CN); HSIN-NAN HU, Tu-Cheng (TW)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/081,466

(22) Filed: Apr. 6, 2011

(30) Foreign Application Priority Data
Sep. 9, 2010 (CN) 201010277256.9

(51) Int. Cl. G06F 3/041

(52) U.S. Cl. 345/173

(57) ABSTRACT

An electronic device includes at least a pair of opposite touch keys defined on a touch panel, a touch sensing unit, a storage unit, a touch control unit, and a CPU. The storage unit stores a key-coordinate area relation list, which defines a relationship between the keys and the coordinate areas. A touch sensing unit included in the touch control unit generates signals in response to user touches on the keys. A touch area determining module included determines the coordinates touched according to the signals, and searching the key-coordinate area relation list to determine the coordinate areas including touched coordinates, and determines whether the touched coordinates distributed in both of the coordinate areas corresponding to the one pair of the pair of opposite touch keys. Then the key determining module determines an “OK” key is touched if yes. The CPU executes a function corresponding. A related method is also provided.

### BACKGROUND

1. Technical Field

The present disclosure relates to electronic devices with navigation keys and, particularly, to an electronic device with navigation keys and navigation method thereof.

2. Description of the Related Art

Most of electronic devices employ navigation keys to control a cursor up, down, left and right, to activate a selection. Five keys in five different directions usually compose the navigation keys. However, when the area of the navigation keys is too small, it is easy to touch several keys at the same time, and make an error.

Therefore, it is beneficial to provide an electronic device to overcome the limitations described.

### BRIEF DESCRIPTION OF THE DRAWINGS

The components in the drawings are not necessarily drawn to scale, the emphasis instead being placed upon clearly illustrating the principles of an electronic device with navigation keys and navigation method thereof. Moreover, in the drawings, like reference numerals designate corresponding parts throughout the several views.

FIG. 1 is a front view of an electronic device with navigation keys in accordance with an exemplary embodiment.

FIG. 2 is a block diagram of the electronic device of FIG. 1 in accordance with an exemplary embodiment.

FIG. 3 is a flowchart of a method capable of executing the function of the navigation keys of FIG. 1 in accordance with an exemplary embodiment.

### DETAILED DESCRIPTION

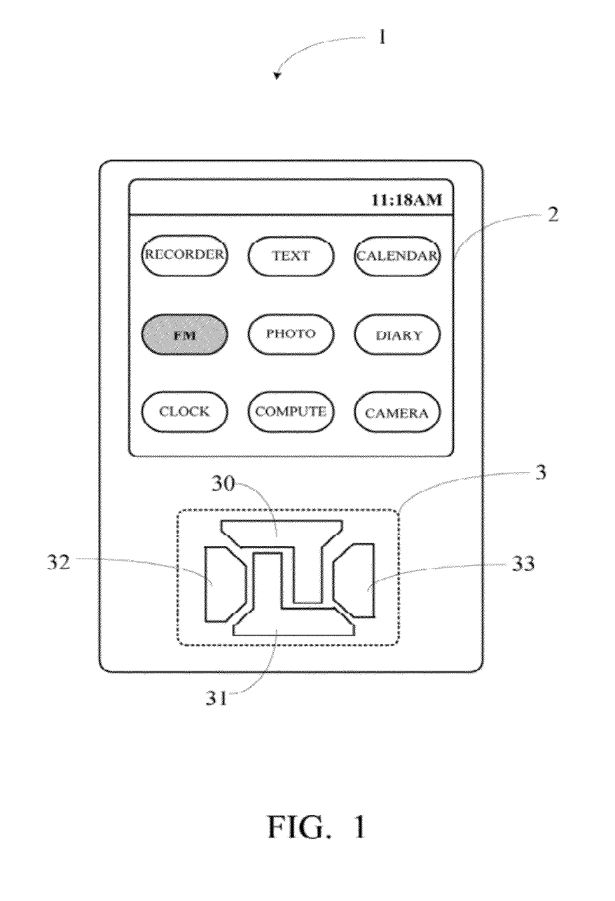

Referring to FIG. 1, an electronic device 1 includes a display screen 2 and a navigation key module 3. In accordance with an exemplary embodiment, the navigation key module 3 is a capacitive touch quad-direction key, mounted on the housing of the electronic device 1 the navigation key module 13 is configured for responding to touches. In an alternative embodiment, the navigation key module 3 is a mechanical quad-direction key mounted on the electronic device 1. The navigation key module 3 includes four keys: an up key 30, a down key 31, a left key 32 and a right key 33.

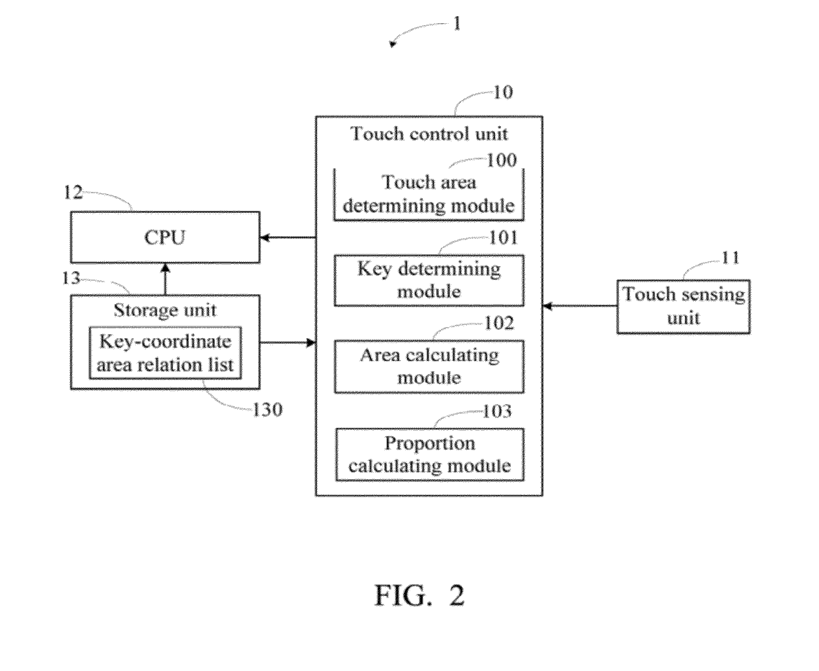

Referring to FIG. 2, the electronic device 1 further includes a touch control unit 10, a touch sensing unit 11, a CPU 12 and a storage unit 13. The storage unit 13 is configured for storing a key-coordinate area relation list 130, which defines a relationship between the keys and the coordinate areas. For example, the coordinate area corresponding to the up key 30 is an area which is defined and surrounded by four coordinates A (20, 20), B (35, 50), C (10, 30) and D (15, 55).

The touch sensing unit 11 is configured for determining whether the navigation key module 3 is touched by users, and generating corresponding signals when being touched.

The touch control unit 10 includes a touch area determining module 100 and a key determining module 101. The touch area determining module 100 is configured for determining the coordinates touched according to the signals generated by the touch sensing unit 11, and searching the key-coordinate area relation list 130 stored in the storage unit 13 to determine the coordinate areas including touched coordinates. The key determining module 101 is configured for determining which key is touched according to the key-coordinate area relation list 130 and the coordinate area determined by the touch area determining module 100. The CPU 12 is configured for executing the corresponding key function according to the key touched determined by the key determining module 101.

Generally speaking, traditional keys shown on the touch panel have an unchangeable size, and the size is small. When a user touches a key, an adjacent key may also be touched at the same time. An error may occur.

To solve the problem, in the embodiments, the touch control module 10 further includes an area calculating module 102 and a proportion calculating module 103. The key-coordinate area relation list 130 further defines a corresponding relationship between an “OK” key (not shown) and coordinate areas. In the embodiments, the coordinate areas corresponding to the “OK” key are coordinate areas of two opposite keys. For example, in the embodiment, the coordinate areas corresponding to the “OK” key are the coordinate areas of the up key 30 and the down key 31. When the touch area determining module 100 determines coordinates in the coordinate areas of the up key 30 and the down key 31 are both touched according to the signals generated by the touch sensing unit 11, the key determining module 101 determines the “OK” key is touched, and the CPU 12 executes a function corresponding to the “OK” key. Therefore, the navigation key module 3 is in fact a navigation key module including five-direction keys, and further errors can be avoided.

The “OK” key is actually a combination of two opposite keys, in the exemplary embodiment, the “OK” key is a combination of the up key 30 and down key 31. That is, the up key 30 and the down key 31 corporately define the “OK” key. Therefore, when both the up key 30 and down key 31 are touched at the same time, the CPU 12 executes a confirmation function. When two keys, except the opposite keys, which corporately define the “OK” key, are touched simultaneously, the touch control unit 10 is further configured to distinguish which key is the key the user intended to touch. In the exemplary embodiment, the area calculating module 102 is configured for calculating a touched area of each touched key. The proportion calculating module 103 is configured for calculating a proportion of the touched area relative to the coordinate area of the corresponding touched key.

The key determining module 101 is further configured for comparing the two proportions calculated by the proportion calculating module 103 and determine the intended key of the user according to the comparison result. In the exemplary embodiment, the intended key corresponds to the larger proportion value. The CPU 12 then executes a function corresponding to the intended key.

For example, the touch area determining module 100 determines the touch coordinates A(20, 25) and B(20, 35) are in the area of the up key 30, and the touch coordinates C(15, 20) and D(15, 35) are in the area of the left key 32, the calculating module 102 respectively calculates touch areas S′₀ and S′₂. The whole area of the up key is S₀, and the whole area of the left key is S₂. The proportion calculating module 103 respectively divides S₀ by S′₀ and divides S₂ by S′₂ to get proportions Y₁(S′₀/S₀) and Y₂(S′₂/S₂). The key determining module 101 compares Y₁ and Y₂. If Y₁>Y₂, the key determining module 101 determines the up key 30 is the intended key, and the CPU 12 controls to execute a “up” function; if Y₁<Y₂, the key determining module 101 determines the left key 32 is the intended key, and the CPU 12 controls to execute a “left” function.

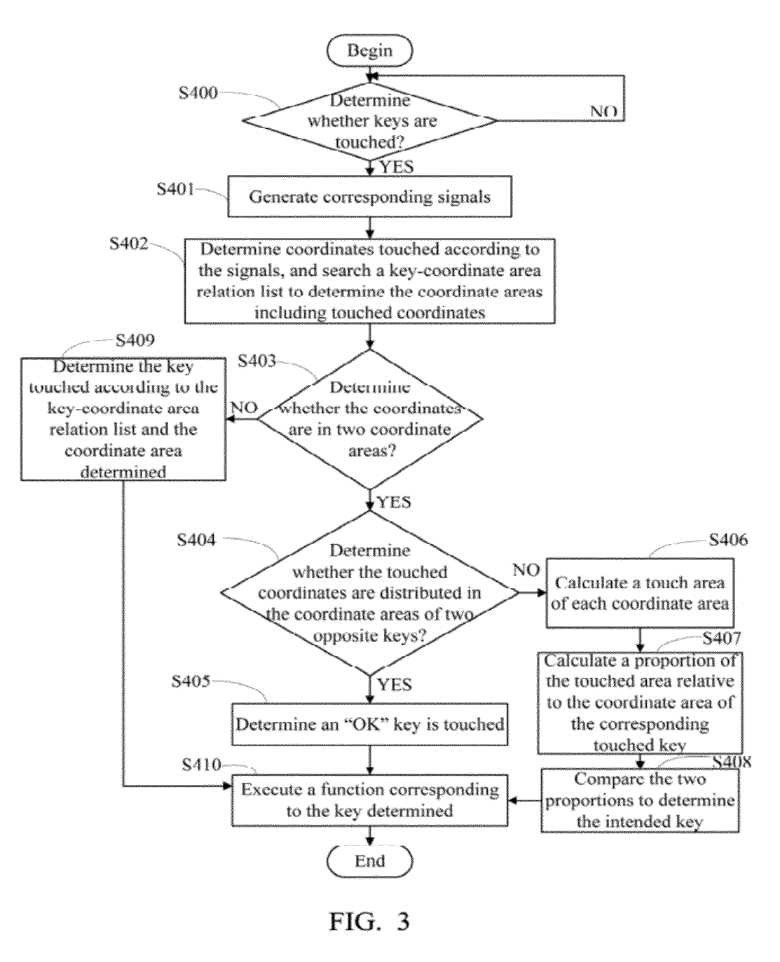

Referring to FIG. 3, a flowchart of a method capable of executing the function of the navigation key in accordance with an exemplary embodiment is shown.

In step S400, the electronic device 1 is started, and the touch sensing unit 11 determines whether the navigation key module 3 is touched by a user, if yes, the procedure goes to step S401; otherwise, the procedure goes to step S400.

In step S401, the touch sensing module 11 generates corresponding signals.

In step S402, the touch area determining module 100 determines the coordinates touched according to the signals generated by the touch sensing unit 11, and searches the key-coordinate area relation list 130 stored in the storage unit 13 to determine the coordinate areas including the touched coordinates.

In step S403, the touch area determining module 100 determines whether the touched coordinates are in two coordinate areas, if yes, the procedure goes to step S404; otherwise, the procedure goes to step S409.

In step S404, the touch area determining module 100 determines whether the touched coordinates distributed in the coordinate areas of two opposite keys which cooperatively define an “OK” key, if yes, the procedure goes to step S405, otherwise, the procedure goes to step S406.

In step S405, the key determining module 102 determines the “OK” key is touched. Then the procedure goes to step S410.

In step S406, the area calculating module 102 calculates a touched area of each coordinate area.

In step S407, the proportion calculating module 103 calculates a proportion of the touched area relative to the coordinate area of the corresponding touched key.

In step S408, the key determining module 101 compares the two proportions calculated by the proportion calculating module 103 and determine the intended key of the user according to the comparison result. Then the procedure goes to step S410. In the exemplary embodiment, the intended key corresponds to the larger proportion.

In step S409, the key determining module 101 determines the key touched according to the key-coordinate area relation list 130 and the coordinate area determined by the touch area determining module 100.

In step S410, the CPU 12 executes a function corresponding to the intended key.

It is understood that the present disclosure may be embodied in other forms without departing from the spirit thereof. Thus, the present examples and embodiments are to be considered in all respects as illustrative and not restrictive, and the disclosure is not to be limited to the details given herein.

What is claimed is:

1. An electronic device, comprising:
at least a pair of opposite touch keys defined on a touch panel;
a touch sensing unit configured for generating signals in response to user touches on the at least a pair of opposite touch keys;
a storage unit configured for storing a key-coordinate area relation list, wherein the key-coordinate area relation list defines a relationship between the at least a pair of opposite touch keys and coordinate areas;
a touch control unit comprising:
a touch area determining module configured for determining coordinates touched according to the signals generated by the touch sensing unit, and searching the key-coordinate area relation list to determine the coordinate areas including the touched coordinates; and further configured for determining whether the touched coordinates distributed in both of the coordinate areas corresponding to the one pair of the at least a pair of opposite touch keys according to the touched coordinates determined;
a key determining module configured for determining an “OK” key is touched when the touched coordinates distributed in both of the coordinate areas corresponding to one pair of the at least a pair of opposite touch keys; and
a CPU configured for executing a function corresponding to the “OK” key.

2. The electronic device as recited in claim 1, wherein the touch control unit further comprises:
an area calculating module configured for calculating a touched area of each touched coordinate areas, when the touch area determining module determines that the touched coordinates are in the coordinate areas of two of the at least a pair of opposite touch keys except the pair of opposite keys which corporately define the “OK” key;
a proportion calculating module configured for calculating a proportion of the touched area relative to the coordinate area of the corresponding touched key; and wherein the key determining unit further configured for comparing the two proportions calculated by the proportion calculating module and determine the intended key corresponds to the larger one of the proportions.

3. The electronic device as recited in claim 2, wherein the CPU is configured for executing a function corresponding to the intended key.

4. The electronic device as recited in claim 1, wherein the at least a pair of keys are capacitive touch quad-direction keys.

5. The electronic device as recited in claim 4, wherein the at least a pair of opposite touch keys comprise an up key and a down key.

6. The electronic device as recited in claim 4, wherein the at least a pair of opposite touch keys comprise an left key and a right key.

7. The electronic device as recited in claim 1, wherein when the touch area determining module determines that the touched coordinates are all included in one of the coordinate areas, the key determining module determines the touched key according to the key-coordinate area relation list, and the CPU executes a function corresponding to the touched key.

8. An executing key function method applied in an electronic device, wherein the electronic device comprises at least a pair of opposite touch keys defined on a touch panel, each of the at least a pair of opposite touch keys corresponds to a coordinate area, the method comprising:
generating signals responding to users' touch on the at least a pair of opposite touch keys;
determining coordinates touched according to the signals, and searching a key-coordinate area relation list to determine coordinate areas including the touched coordinates;
determining whether the touched coordinates are distributed in two coordinate areas;
determining whether the touched coordinates are distributed in two coordinate areas corresponding to one pair of the at least a pair of opposite touch keys if the touched coordinates are distributed in two coordinate area;
determining an “OK” key is touched if the touched coordinates are distributed in the coordinate areas corresponding to one pair of the at least a pair of opposite keys; and
executing a function corresponding to the “OK” key.

9. The method as recited in claim 8, wherein the key-coordinate area relation list defines a relationship between the locations of the at least a pair of opposite touch keys and the coordinate areas.

10. The method as recited in claim 8, further comprising:
calculating a touched area of each coordinate area when the touched coordinates are not distributed in two coordinate areas corresponding to one pair of the at least one pair of opposite touch keys;
calculating a proportion of the touched areas relative to the coordinate area;
comparing the proportions calculated and determining an intended key according to the comparison result, wherein the intended key corresponds to a larger one of the proportions; and
executing a function corresponding to the intended key.

11. The method as recited in claim 8, further comprising:
determining a key touched according to the key-coordinate area relation list and the coordinate area determined when the coordinates touched are all in one coordinate areas.
